(19) United States
(12) Patent Application Publication
(10) Pub. No.: US 2012/0314032 A1
(43) Pub. Date: Dec. 13, 2012

(54) METHOD FOR PILOT ASSISTANCE FOR THE LANDING OF AN AIRCRAFT IN RESTRICTED VISIBILITY

(75) Inventors: Thomas MUENSTERER, Tettnang (DE); Peter KIELHORN, Friedrichshafen (DE); Matthias WEGNER, Friedrichschafen (DE)

(73) Assignee: EADS DEUTSCHLAND GMBH, Ottobrunn (DE)

(21) Appl. No.: 13/480,798

(22) Filed: May 25, 2012

(30) Foreign Application Priority Data
May 27, 2011 (EP) 11004366.8

(51) Int. Cl. H04N 13/02

(52) U.S. Cl. 348/46; 348/E13.074

(57) ABSTRACT

Method for pilot assistance in landing an aircraft with restricted visibility, in which the position of a landing point is defined by at least one of a motion compensated, aircraft based helmet sight system and a remotely controlled camera during a landing approach, and with the landing point is displayed on a ground surface in the at least one of the helmet sight system and the remotely controlled camera by production of symbols that conform with the outside view. The method includes one of producing or calculating during an approach, a ground surface based on measurement data from an aircraft based 3D sensor, and providing both the 3D measurement data of the ground surface and a definition of the landing point with reference to a same aircraft fixed coordinate system.

### CROSS-REFERENCE TO RELATED APPLICATIONS

The present application claims priority under 35 U.S.C. §119(a) of European Patent Application No. 11 004 366.8 filed May 27, 2011, the disclosure of which is expressly incorporated by reference herein in its entirety.

### BACKGROUND OF THE INVENTION

Helicopter landings in restricted visibility conditions represent an enormous physical and mental load for the pilots, and involve a greatly increased accident risk. This applies in particular to night-time landings, landings in fog or snow fall, as well as landings in arid environments, which lead to so-called “brownout.” In this case, brownout means an effect which is caused by the rotor downwash of the helicopter and which can lead to complete loss of outside visibility within fractions of a second. A similar effect occurs during landings on loose snow, and this is referred to as “whiteout.” Assistance systems for the risk scenarios mentioned above are in general intended to be designed such that the pilot is provided with his normal approach behavior, possibly with assistance for it, but providing him with the necessary aids in the event of loss of outside visibility in order to land safely.

Known methods for pilot assistance use Symbology, which is reflected into the helmet sight system of the pilot. The pilot can therefore observe the landing zone throughout the entire landing process, but in the process important information for the landing approach is overlaid on this outside view, in the helmet sight system, such as drift, height above ground or a reference point.

Investigations into the workload of pilots when landing in restrictive visibility conditions have shown that simultaneous coordination of the real outside view and two-dimensional symbols is difficult. A high level of concentration is required to process all of the information which is important for the landing, at the same time, from different types of symbols. Under the stress which a landing such as this causes, particularly in military operational conditions, pilots therefore have a tendency to ignore individual display information items. A display zymology is therefore required which intuitively provides the most important flight parameters, such as drift, orientation in space and height above ground, in a manner which is as similar as possible to a normal landing in visual flight conditions. In principle, this can be achieved by symbols which conform with the outside view and by graphic structures/objects which are overlaid in the helmet sight system. The viewing direction of the helmet sight system for the display must also be compensated for zymology such as this which conforms with the outside view (compensation for head movement).

Zymology which conforms with the outside view makes it possible to display to the pilot, for example, the landing point during the approach and during the landing as if the corresponding landing point marking, i.e., the appropriate symbol, were positioned in the real outside world on the landing area. Additional synthetic reference objects, as well as images of real obstructions, can also be overlaid in the helmet sight system as an orientation aid for the pilot.

Various approaches already exist for displaying zymology, which conforms with the outside view, of the intended landing point in the helmet sight system.

WO 2009/081177 A2 describes a system and a method by which the pilot can mark and register a desired landing point by the helmet sight system, by focusing on said desired landing point and operating a trigger. For this purpose, the described approach makes use of the visual beam of the helmet sight system, data from a navigation unit and an altimeter. In addition, the ground surface of the landing zone is either assumed to be flat or is assumed to be capable of calculation by database information. It is proposed that a landing area marking, as well as synthetic three-dimensional reference structures, preferably in the form of cones, be displayed, conforming with the outside view, in the helmet sight system, on the assumed ground area of the landing area.

In one variant of the method, a rangefinder is also used to stabilize the definition function of the landing area. The use of 3D sensors is mentioned only in conjunction with the detection of obstructions in or adjacent to the landing zone and for production of an additional synthetic view on a multifunction display.

Furthermore, this known method describes a method for minimizing measurement errors, which lead to errors in the zymology display. In this case, however, elevation errors and specification gaps when the database is used are not mentioned. In fact, the method proposes multiple marking of the landing area, until the result is satisfactory. This has a negative effect on the workload and the necessary change to the standard approach process and makes use of nothing with respect to specific errors which are present in real systems (for example a sudden change in the position data when a GPS position update takes place). The technical complexity when using a range finder which, of course, must be aligned with the line of sight of the helmet sight system, i.e., it must be seated on a very precise platform which can be rotated on two axes, is likewise disadvantageous.

In Goff et. al., “Developing a 3-D Landing Symbology Solution for Brownout,” Proceedings of the American Helicopter Society 66th Annual Forum, Phoenix, Ariz., May 11-13, 2010 discloses the grid network of the ground surface of an existing elevation database being displayed in the helmet sight system for pilot assistance, said grid network having been referenced via a precise navigation system and measurement of the height above ground. In the same way as that described in WO 2009/081177 A2, synthetic three-dimensional structures (but in this case cuboid towers) are projected onto this ground surface in the helmet sight system, as an orientation aid for the landing pilot. This synthetic scenario is overlaid in a helmet sight system for the pilot, conformally with his real outside view, with motion compensation.

In a similar manner to that in WO 2009/081177 A2, this also offers the capability to mark the landing area by a reticule at the center of the field of view of the helmet sight system from a relatively long range (between 600 and 1000 m). A computer determines the absolute position of the landing point to be reached, from the intersection of the straight line of the viewing angle of the helmet sight system and the database-based ground surface.

This method has the disadvantage of the need to use elevation databases, whose availability and accuracies are highly restricted. According to specification, by way of example, a terrain database of DTED Level 2 resolution, i.e., with a support point interval of about 30 m, has a height error of up to 18 m and a lateral offset error of the individual support points in the database of up to 23 m. Another disadvantage is that, when using databases, it is necessary to know the current absolute position of the aircraft. In the case of navigation systems which do not have differential GPS support, an additional position error of several meters also occurs. In order to allow the described method to be used in a worthwhile manner at all for landing purposes, so-called height referencing of the database data must be carried out by an additional height sensor. In this case, the height of the aircraft above ground is measured accurately during the approach, and the absolute altitude in the entire database is corrected such that the values match again.

This method has the weakness that the altimeter measures the distance to the nearest object, although this is not necessarily the ground, but may also typically be objects which are present, such as bushes or trees. Objects such as these are generally not included in a terrain database, and error correction is therefore carried out. An additional negative effect which should be noted is that the method relies on the characteristic, which is not specified for this scale, of the relative height accuracy between different database points in the database. A further disadvantage of the method is that the database data is typically not up to date.

The described disadvantages represent a considerable operational weakness of the method, since the symbols to be displayed are frequently subject to height errors, that is to say the symbols either float in the air for the pilot or sink in the ground, and short-notice changes in the landing zone are not taken into account. The described systems visually display symbols which conform with the outside view and are intended to assist the pilot when landing in reduced visibility conditions in brownout or whiteout. However, in the prior art, a flat assumption or a terrain database is used as the projection area onto which the synthetic symbols are placed. However, the availability and accuracy of elevation databases is inadequate for landing purposes. Furthermore, the use of terrain databases necessitates the use of navigation installations with high absolute own-position accuracy, and this has a disadvantageous effect on the costs of a system such as this.

DE 10 2004 051 625 A1 describes a helicopter landing aid specifically for brownout and whiteout conditions, in which a synthetic 3D view of the surrounding area is displayed in perspective form to the pilot on a display during the brownout or whiteout, with the virtual view being generated on the basis of 3D data, which was accumulated during the landing approach before the brownout started. No provision is made to display symbols superimposed on the synthetic outside view.

### SUMMARY OF THE EMBODIMENTS

Embodiments of the present invention provide a method for pilot assistance in particular for the above-described brownout and whiteout scenarios, in which landing area zymology is displayed with high accuracy and using an up-to-date database.

Accordingly, embodiments can be directed to a method for pilot assistance for the landing of an aircraft in restricted visibility, with the position of the landing point being defined by a motion-compensated, aircraft-based helmet sight system during the landing approach, and with the landing point being displayed on a ground surface in the helmet sight system by the production of symbols which conform with the outside view. The method includes that the production or calculation of the ground surface is based on measurement data, produced during the approach, from an aircraft-based 3D sensor, and both the production of the 3D measurement data of the ground surface and the definition of the landing point are provided with reference to the same aircraft-fixed coordinate system.

The present invention describes zymology for displaying the intended landing point, displayed in a helmet sight system which is superimposed conformally on the real outside view of the pilot. The symbols are placed to conform with the outside view, within a synthetic 3D display of the terrain. In this case, the display in the helmet sight system is subject to correct-position and correct-height size, alignment and proportion matching corresponding to the view of the pilot. According to the invention, the 3D data relating to the terrain area is produced by an active, aircraft-based 3D sensor during the landing approach.

Since the landing point is defined using the helmet sight system together with the active 3D sensor, the accuracy of positioning is considerably increased in comparison to the prior art. Since both the helmet sight system and the 3D sensor produce their display and carry out their measurements using the same aircraft-fixed coordinate system, only relative accuracies of an aircraft's own navigation installation are advantageously required for this purpose. Against this background in particular, it is of major importance that the landing approach of a helicopter takes place from a relatively low altitude, in particular during military operations. This in turn means that the pilot has a correspondingly flat viewing angle to the landing zone. An error in the angle measurement in the marking of the landing point by helmet-sight direction finding in these conditions has an increased effect on the accuracy of the position determination in the direction of flight.

Furthermore, the use of the 3D sensor for displaying the terrain area ensures high-precision and in particular up-to-date reproduction of the conditions at the landing point, which a terrain database cannot, of course, provide.

Preferably a ladar or a high-resolution millimetric waveband radar is used as the 3D sensor. Furthermore, however, other methods may also be used for production of high-precision 3D data relating to the scenario in front of the aircraft, within the scope of the present invention.

In one specific embodiment, only the data of a 3D measurement line of a 3D sensor is determined, with the forward movement of the aircraft resulting in flat scanning of the landing zone (so-called pushbroom method).

Alternatively, it is also possible to use a 2D camera system for determination of the depth information if the position offset is known between the individual images, using known image processing algorithms, for example “depth from motion” or stereoscopy. The complete system comprising the camera and image processing then once again results in a 3D sensor for the purposes of the present invention.

In an advantageous addition to the inventive concept, additional visual references in the form of three-dimensional graphic structures can be produced from the 3D data from the active 3D sensor. These are derived by geometric simplification from the raised non-ground objects (for example buildings, walls, vehicles, trees, etc.), and are overlaid in perspective form in the helmet sight.

The graphic structures for displaying non-ground objects, for example cuboids, cylinders or cones, form a simplified image, which conforms with the outside view, of real objects in the area directly around the landing zone, and are used as additional, realistic orientation aids.

Embodiments of the invention are directed to a method for pilot assistance in landing an aircraft with restricted visibility, in which the position of a landing point is defined by at least one of a motion compensated, aircraft based helmet sight system and a remotely controlled camera during a landing approach, and with the landing point is displayed on a ground surface in the at least one of the helmet sight system and the remotely controlled camera by production of symbols that conform with the outside view. The method includes one of producing or calculating during an approach, a ground surface based on measurement data from an aircraft based 3D sensor, and providing both the 3D measurement data of the ground surface and a definition of the landing point with reference to a same aircraft fixed coordinate system.

According to embodiments, the method can further include calculating, both in the aircraft fixed coordinate system and in a local, ground fixed relative coordinate system, geometric position data of landing point symbols. An instantaneous position in space and an instantaneous position of the aircraft are used for converting between the two coordinate systems, in which the instantaneous position of the aircraft results from relative position changes of the aircraft with respect to its position at a selected reference time.

In accordance with other embodiments of the invention, the landing point can be defined by finding a bearing of the landing point in the helmet sight system and subsequent marking by a trigger.

According to still other embodiments, the method may include correcting, via a control element, the position of the landing point symbol displayed in the helmet sight system.

In accordance with other embodiments, the landing point symbols can include at least one of an H, a T and an inverted Y.

Moreover, the method may also include displaying at least one additional visual orientation aid, which conforms with an outside view and comprises a 3D object in the helmet sight system. The at least one additional visual orientation aid is derived from a real object within an area around the landing point. Further, the 3D data of the real object may be produced by the 3D sensor during the approach. The orientation aid can also include an envelope of the real object. Further, the orientation aid can assume a geometric basic shape comprising at least one of a cuboid, cone or cylinder, or combinations thereof. Still further, when there is a plurality of real objects within the landing zone, the method may further include determining the suitability of the plurality of real objects as an orientation aid via of an assessment algorithm, and displaying the objects that are most suitable as orientation aids.

According to other embodiments, the method can include displaying an additional, synthetic orientation aid, which conforms with the outside view and comprises a virtual wind sock in the helmet sight system.

According to still further embodiments, the method can include an additional synthetic orientation aid, which conforms with the outside view and comprises a virtual glide angle beacon in the helmet sight system, in order to assist the approach at the correct glide path angle. The virtual glide angle beacon comprises at least one of VASI (Visual Approach Slope Indicator) or PAPI (Precision Approach Path Indicator).

Embodiments of the invention are directed to a method to assist landing an aircraft in an area of limited visibility. The method includes focusing on a landing point via one of a helmet system and a camera, measuring a line of sight to the landing point, 3 dimensionally measuring an area that includes the landing point, and displaying symbols corresponding to an intersection of the line of sight and the 3 dimensionally measured area in the one of the helmet system and the camera.

According to embodiments, measurement of the line of sight to the landing point may be triggered by a pilot.

In accordance with further embodiments of the invention, the method can include correcting a location of the displayed the symbols according to additional measurements of the line of sight to the landing point and the area including the landing point.

In accordance with still yet other embodiments of the present invention, the symbols may include at least one of an H, a T and an inverted Y.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a schematic overview of a system for implementation of the method according to the invention;

FIG. 2 shows a flowchart for marking and definition of the landing point by helmet sight direction finding;

FIG. 3 shows a sketch of the geometric relationships for the marking of the landing zone during the approach;

FIG. 4 shows a view of the measurement point cloud of the 3D sensor at the location of the intersection with the viewing beam of the helmet sight system;

FIG. 5 shows a view of the measurement point cloud at the location of the intersection with emphasized scan lines from the 3D sensor;

FIG. 6 shows a view of the measurement point cloud at the location of the intersection with measurement points which are selected for ground surface approximation;

FIG. 7 shows a view of the measurement point cloud of the location of the defined landing point with measurement points, selected for ground area approximation, within a circle around the defined landing point;

FIG. 8 shows a sketch of the processing path from the measurement point selection via the ground area approximation to the projection of landing zymology onto this ground surface, as far as back-transformation of this landing zymology to an aircraft-fixed coordinate system;

FIG. 9 shows an exemplary illustration of the landing point symbol together with standard flight-guidance symbols in the helmet sight system;

FIG. 10 shows an exemplary illustration of the landing point symbol and of an additional orientation aid, which is based on real objects in the area of the landing zone, together with standard flight-guidance symbols in the helmet sight system; and

FIG. 11 shows an exemplary illustration of the landing point symbol with additional, purely virtual, orientation aids (wind sock, glide-angle beacon).

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

### System Configuration:

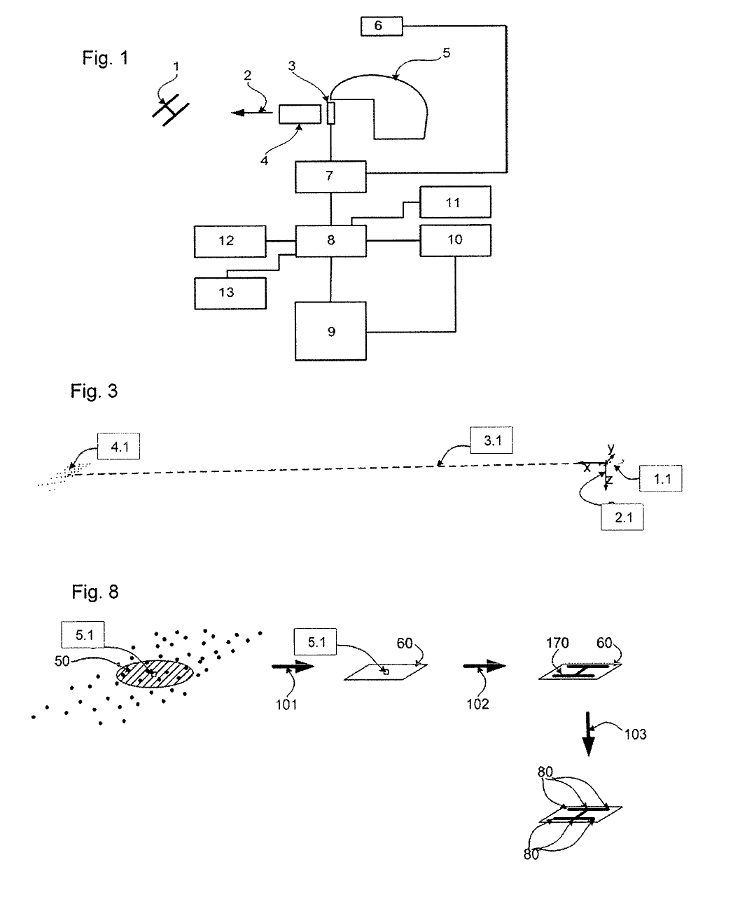

FIG. 1 shows the system configuration for carrying out the method according to the invention, illustrated schematically.

The pilot observes a landing zone 1 through a helmet sight system 3 which is attached to a helmet 5. For the purposes of the present invention, the helmet sight system 3 can include display systems for one eye or else for the entire viewing area. The technique for image production on the helmet sight system 3 is not critical in this case. The line of sight of the pilot is identified by the arrow designated with reference number 2. In addition, the outside view for the pilot can be improved by image-intensifying elements 4 (so-called NVGs), for example at night. The head movement of the pilot is measured by a detection system 6 for the spatial position of the head or of the helmet, and therefore of the helmet sight system 3. This ensures that the line of sight of the pilot and therefore of the helmet sight system 3 is measured. This data is typically passed to a computer unit 7 for the helmet, which is responsible for displaying the zymology on the helmet sight system 3, and for display compensation for head movement. This computer unit 7 may either directly be a part of the helmet sight system 3 or may represent an autonomous physical unit. The landing zone 1 is at the same time recorded continuously by a 3D sensor 9. The data from the 3D sensor 9 is advantageously stored both in an aircraft-fixed relative coordinate system, and in a local, ground-fixed relative coordinate system. The instantaneous motion and body-angle measurement data from a navigation unit 10 are used for conversion between the two local coordinate systems. This data is used in a processor unit 8 to calculate the desired landing point, on the basis of the method described in more detail in the following text, and to calculate the symbol positions in aircraft-fixed coordinates. Additional reference symbols, abstracted from the raised non-ground objects, and their relative position are likewise calculated in the processor unit, from the 3D data. The data from the navigation unit 10 is used for geometric readjustment of the zymology produced in the processor unit. The processor unit 8 may either be an autonomous unit or else advantageously may be computation capacity made available by the 3D sensor 9. The reference number 12 denotes a trigger, which is used to define the landing point and is advantageously integrated as a switch or pushbutton on one of the aircraft control columns. In addition, the system optionally has a control unit 13, by which the position of the selected landing point can be corrected in the helmet sight system 3. This can advantageously be formed by a type of joystick on one of the control columns.

The method according to the invention is intended in particular for use in manned aircraft controlled by a pilot, but can also be applied to other aircraft with increased automation levels. For example, another application according to the invention would also be for the pilot to simply define the landing position by helmet sight direction finding, with the approach and the landing then being carried out completely automatically. All that would be required for this purpose would be to transmit the position of the selected landing position to the Flight Management System (FMS) 11. Use of the present method according to the invention is also envisaged for an airborne vehicle without a pilot flying in it, a so-called “drone.” In this case, the helmet sight system 3 would preferably be replaced by a camera system for the remotely controlling pilot on the ground. This then likewise provides this pilot with the capability to define the landing position analogously to the method described in the following text.

### Definition of the Landing Point:

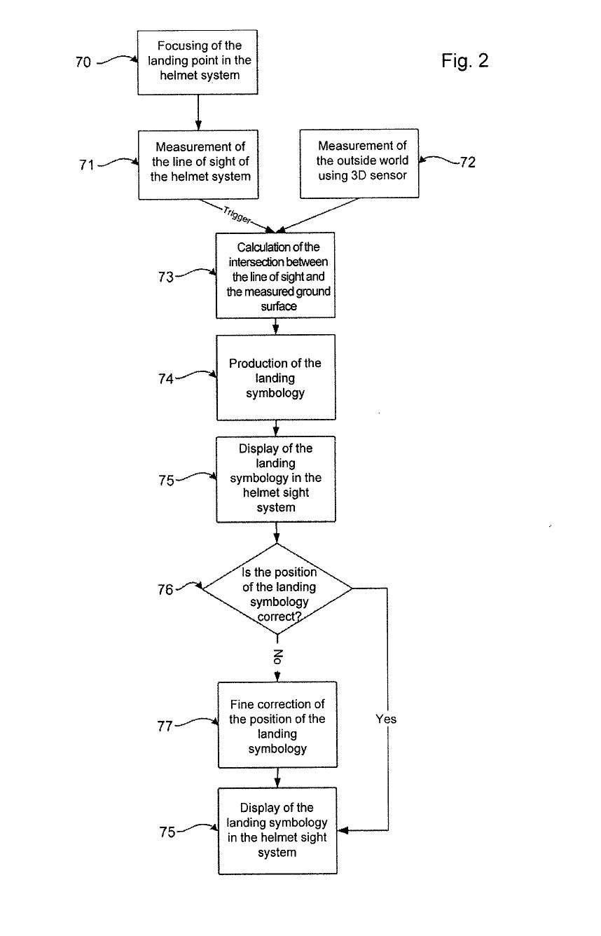

The precise landing point is defined using lines and/or arrows to the desired point on the earth's surface by the helmet sight system 3. For this purpose, a type of reticule is overlaid in the helmet sight system 3, in general at the center of the field of view. An example of the process is illustrated in FIG. 2. The pilot turns his head such that the desired landing position sought by him corresponds with the reticule (step 70). This line of sight is aligned by the helmet sight system 3 (step 71). The pilot then operates a trigger, for example on a button on one of the control columns in the aircraft. This trigger results in the instantaneous line of sight of the helmet sight system 3 being transmitted to a processor unit 8, in aircraft-fixed coordinates. This processor unit 8 now calculates the intersection of the line of sight (step 73) with the measurement point cloud of the ground surface (step 72) recorded at the same time by the 3D sensor 9, and places a landing point symbol on this measured ground surface (steps 74 and 75). Throughout the entire approach, the pilot can check the correct position of the landing zymology (step 76) and if necessary can correct its lateral position (step 77). This fine correction is in turn included in a renewed display of the landing zymology. The position monitoring process and the fine correction can also be carried out repeatedly.

FIG. 3 shows, to scale and by way of example, the distances which typically occur during a helicopter landing approach. The aircraft 1.1 is typically between 400 and 800 m away from the landing point at the time when the landing point is marked. An aircraft-fixed coordinate system 2.1 is defined at this time. The line of sight of the helmet sight system 3.1 passes through the ground surface produced by the 3D measurement point cloud 4.1 from the 3D sensor 9.

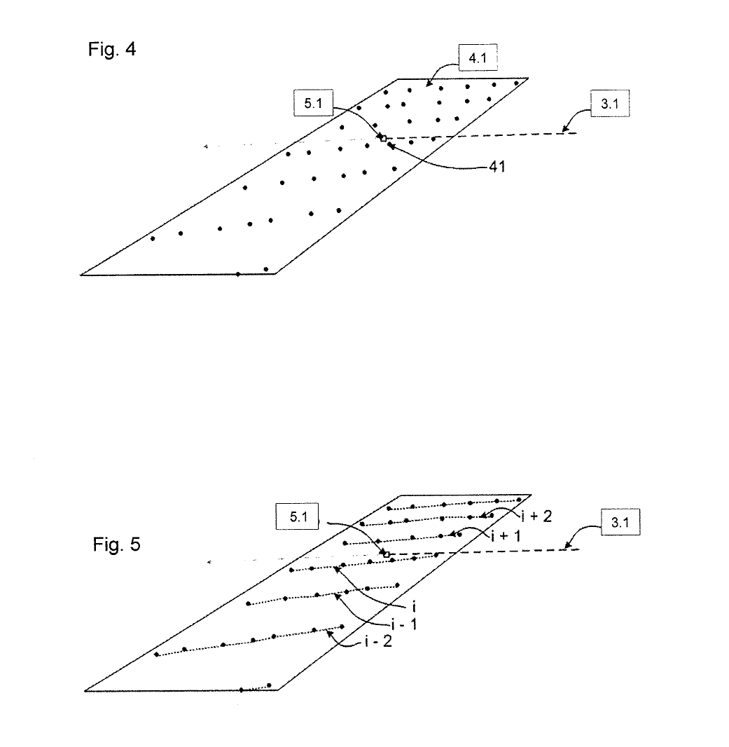

If the intersection 5.1 (see FIG. 4) of the sight beam 3.1 with the 3D measurement point cloud 4.1 is considered in more detail, it becomes evident that a measurement point 41 can be found for each angle of the sight beam 3.1, which measurement point 41 is closest to the intersection. In order to define the landing position and therefore to place the landing zymology, an area approximation must now be made of the surrounding measurement points associated with the ground surface. When calculating this surface approximation, it is necessary to remember that the typically very flat viewing angle results in the measurement points of a measurement point field distributed at equal intervals in space being heavily distorted, or stretched. A marking distance of 400 m at an altitude of 30 m will be considered by way of example. If a high-resolution 3D sensor 9 has a measurement point separation of 0.3° in the horizontal and vertical directions, then the distance between two adjacent measurement points in these conditions is approximately 4 m transversely with respect to the direction of flight, and approximately 25 m in the direction of flight. The surface approximation of the 3D measurement points on the ground must therefore be calculated on a range of measurement points which provides points at a sufficient distance apart in both spatial directions. A method as described in the following text is considered to be advantageous for a sensor having measurement points at approximately equidistant solid angles.

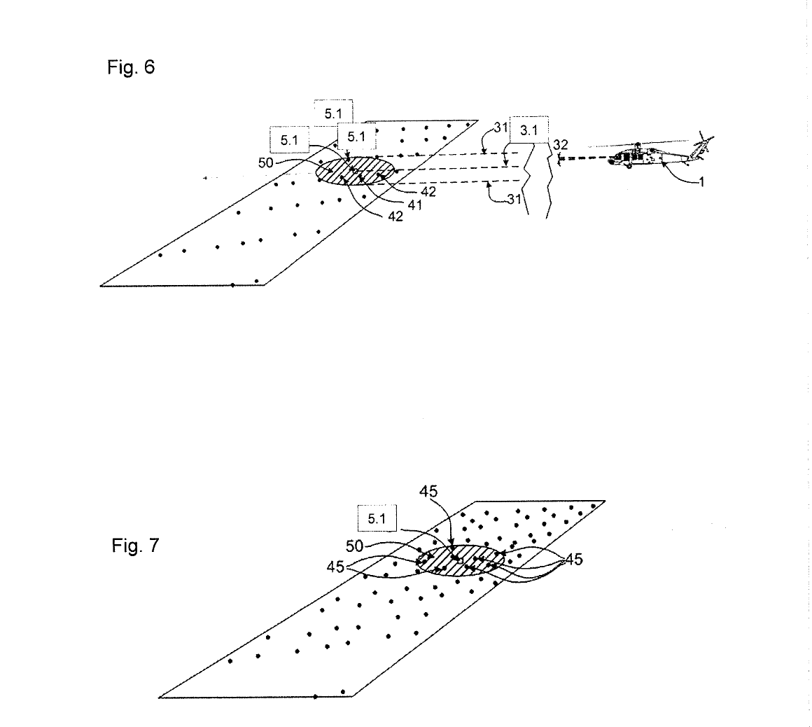

It is assumed, without any restriction to generality, that the measurement points from the 3D sensor 9 are split into columns with the index j and lines with the index i (see FIG. 5). A distance value as well as an azimuth angle ψ_{S} and an elevation angle θ_{S} are measured directly by the 3D sensor 9 for each measurement point with the indexes i and j. These measurement angles are already intended to be in an aircraft-fixed coordinate system (cf. reference number 2.1, FIG. 3), or can be converted to this. As described above, a viewing angle, likewise consisting of an azimuth angle ψ_{H} and an elevation angle θ_{H}, is transmitted by the helmet sight system 3. These angles are typically also measured directly in the aircraft-fixed coordinate system. It is also assumed that the measurement point annotated with the reference point 41 in FIG. 4 and FIG. 6 is that whose angles ψ_{S,i/j} and θ_{S,i/j} are closest to the viewing angle ψ_{H} and θ_{H}. The reference point 41 now has the index pair i and j. In order to calculate a ground surface approximation for the landing zymology, all those points are now considered whose azimuth and elevation angles are within an angle range ε (see reference number 32 in FIG. 6) around the viewing angle pair ψ_{H} and θ_{H}. These points are annotated with the reference numbers 41 and 42 in FIG. 6. The angle range ε can advantageously be chosen such that it is equal to or greater than the beam separation of the 3D sensor 9. This ensures that, in general, at least one point from an adjacent scan line (in this case reference point 43 in FIG. 6) is also included in the surface calculation.

In one advantageous version of the described method, only measurement points from the 3D sensor 9 which have previously been classified as ground measurement values using segmentation methods known per se are included in the calculation of the approximation of the ground surface. This makes it possible to preclude errors in the calculation of the ground surface resulting from measurement points on raised objects. For this method, it may be necessary to enlarge the angle range c until a valid ground measurement value of an adjacent scan line can also be included.

A ground surface is approximated by the set of measurement points obtained in this way. The intersection between the sight beam of the helmet sight system 3 and this ground surface is advantageously calculated in an aircraft-fixed coordinate system. The landing zymology to be displayed is placed on the calculated ground surface, and the landing point selected in this way is in the form of a geometric location in the aircraft-fixed coordinate system.

This method has the advantage that the measurements from the 3D sensor 9 are provided in the same aircraft-fixed coordinate system (reference number 2.1, FIG. 3) in which the viewing angle measurement of the helmet sight system 3 is also carried out. Therefore, the intersection between the sight beam 3.1 and the measured ground surface can advantageously be calculated using relative angles and distances. For this reason, only the very minor static orientation errors of the helmet sight system 3 and 3D sensor 9 are advantageously included in an error analysis. The pitch, roll and course angles of the navigation system (and therefore their errors) are not included in the determination of the desired landing position. In the known database-based method, pitch, roll and course angles are in contrast required from the navigation system as well as the geo-referenced absolute positions of the aircraft, in order to determine the landing point.

Display of Landing Point Zymology which Conforms with the Outside View:

A known landing symbol which conforms with the outside view and with which the pilot is familiar is now projected in perspective form correctly onto the landing area at the local position of the landing point as defined according to the invention. In this case, symbols which have as little adverse effect as possible on the outside view through the helmet sight system 3 are preferred. For this reason, the present method deliberately dispenses with displaying the landing area by a ground grid network. The landing point itself is marked unambiguously by a symbol which is projected on the landing area on the ground. This can advantageously be done using an “H”, a “T” (“NATO-T”) or an inverted “Y” (“NATO inverted-Y”). These symbols are familiar to pilots, in particular military pilots, and a landing approach based on these symbols, whose size, orientation and proportions in the real world are known, is routine to pilots. For this reason, the perspective shortening of the respective symbol in the helmet sight system 3 gives the pilot a precise impression of the approach angle (slope angle). In addition, the alignment of the symbol describes the desired approach direction. Because of the stated relationships, the training effort for a pilot to handle the zymology according to the invention, which conforms with the outside view, is advantageously reduced.

The landing point, which has been defined on the basis of the method described above in aircraft-fixed coordinates, is fixed for the approach in a local, ground-fixed relative coordinate system. All position changes of the aircraft from the time of the landing point definition are considered relatively to a local starting point. The instantaneous position difference from the defined landing point results from a position change of the aircraft, which is easily calculated from the integration of the vectorial velocity of the aircraft, taking account of the position changes over the time since a zero time. In this case as well, it is an advantageous characteristic that only position errors relative to this local starting point (for example the position of the aircraft at the time when the landing point was defined) are relevant. A coordinate system such as this is in consequence referred to as an earth-fixed relative coordinate system.

During the landing approach to the selected landing position, 3D data is continuously recorded from the 3D sensor 9. This data is transformed to the earth-fixed relative coordinate system, and can also in this case advantageously be accumulated over a number of measurement cycles. Analogously to the method according to the invention as described above for definition of the landing point, measurement points in a predefined circular area 50 around the defined landing point 5 (FIGS. 7 and 8), which have been classified as ground measurement points 45, are used for continuous calculation of the ground surface 60 (FIG. 8) by surface approximation 101. The selected symbol 170 for the landing point is then correctly projected, in perspective form, onto this ground surface 60. Since the ground surface can in general be scanned with better resolution by the 3D sensor 9 the closer one is to this surface, this process has the advantage that the measurement accuracy is scaled to the same extent to that for which the requirement for the display accuracy in the helmet sight system 3 is scaled. The landing zymology in the earth-fixed relative coordinate system is in turn transformed with the aid of the position angles and velocity measurements from the navigation installation back to the aircraft-fixed coordinate system. After back-transformation, the landing zymology is transmitted to the helmet sight system 3, and is appropriately displayed by it. The back-transformation allows the landing zymology to be displayed in the pilot's helmet sight system 3 such that it is always up to date, is correct in perspective form, and conforms with the outside view.

Since the landing zymology is displayed throughout the entire final landing approach, that is to say also over a relatively long time in normal visual conditions, this advantageously makes it possible for the pilot to monitor the correctness of the zymology during the approach, i.e., it is obvious to the pilot whether the landing zymology also actually conforms with the real ground surface of the outside view. In the event of discrepancies or desires for correction, the pilot can laterally shift the position of the zymology as desired via a control unit, as illustrated by the reference number 13 in FIG. 1, for example, by a type of joystick.

When using an optical 3D sensor 9, for example, a ladar, new measurement values for calculation of the ground surface are no longer added as soon as the aircraft enters the area of restricted visibility in the situation where restricted visibility occurs, as a result of a brownout or whiteout, suddenly but in a manner which an optical sensor can penetrate only with difficulty. In this case, the ground surface from the active 3D sensor 9, as obtained before the onset of the restricted visibility, can still be used, and its position is corrected using the data from the aircraft navigation installation.

It is likewise possible to use only that 3D sensor 9 data for which the method has reliably ensured that the data does not represent incorrect measurements of dust or snow particles.

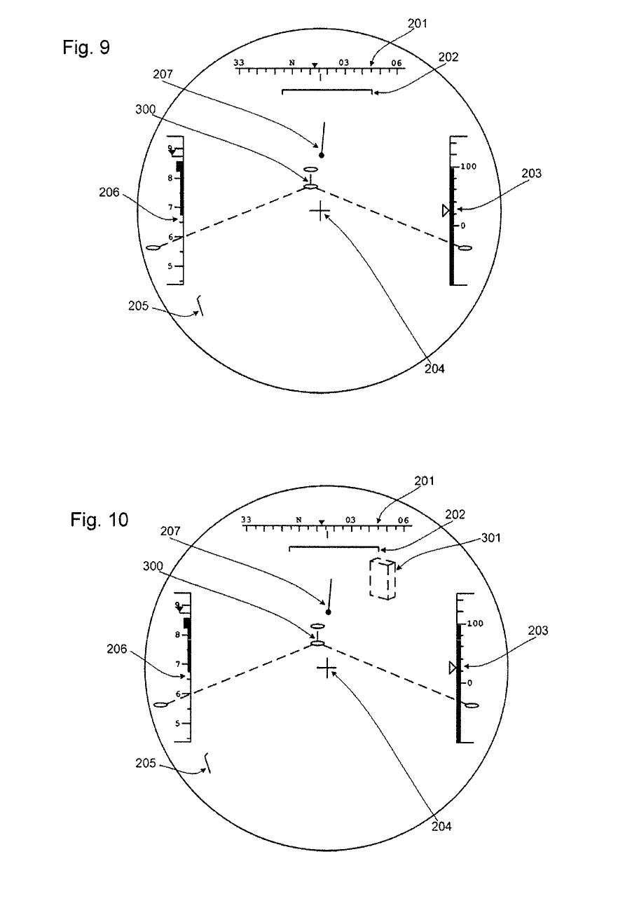

The use of the symbols described above, particularly of the “T” symbol and of the inverted “Y”, makes it possible to also display zymology on helmet sight systems which allows only a restricted number of symbols to be displayed in addition to the already existing flight-guidance symbols. For example, in order to draw the inverted “Y”, only 4 circles are required for the support points and possibly 3 lines for the connections. By way of example, FIG. 9 shows the display of the inverted “Y” 300 together with standard flight-guidance zymology: compass 201, horizon line 202, height above ground 203, center of the helmet sight system 204, wind direction 205, engine display 206, drift vector 207.

In one advantageous version of the described method, the data for the zymology which conforms with the outside view and the data for the flight-guidance zymology originate from different sources. This means that, for example, the flight-guidance zymology is produced directly from navigation data by the helmet sight system, while data for the zymology which conforms with the outside view is produced by a separate processor unit, and is sent as character coordinates to the helmet sight system.

Display of the Zymology, which Conforms with the Outside View, of Additional Orientation Aids:

The invention also proposes that additional reference objects or orientation aids which conform with the outside view not be displayed as a purely virtual symbol without specific reference to the outside world, but be displayed derived from real objects in the landing zone.

In most cases, objects which are clearly raised above the ground, such as bushes, trees, vehicles, houses, walls, or the like, are present in the area in front of the defined landing point. The method according to the invention selects from the raised objects which are present that object or those objects which is/are most suitable for use as a visual orientation aid. For this purpose, the method takes account of objects which are suitable for use as an orientation aid and which are located in the hemisphere in front of the defined landing point. In addition, suitable orientation aids should not be too small, and also should not be too large, since they otherwise lose their usefulness as a visual reference during the landing approach. A three-dimensional envelope, preferably a simple geometric basic shape such as a cuboid, cone or cylinder, can advantageously be drawn around the suitable raised object or objects. A suitable reference object as a visual orientation aid is placed accurately in position on the ground surface calculated from 3D sensor data, and is subsequently readjusted, and appropriately displayed, such that it conforms with the outside view.

At the time when the landing point is defined by helmet sight direction finding, all the raised objects above the ground surface which are detected by the sensor can first of all be segmented from the 3D data. The distance to the landing point and the direction between the object location and the landing direction are determined for each object which has been segmented in this way. In addition, the extent transversely with respect to the direction of flight and the object height are determined. These and possibly further object characteristics are included in a weighting function which is used to select the most suitable orientation aid from a possibly existing set of raised objects. The influence of some of these variables will be described qualitatively by way of example: an object which is too small or too far away offers little basis for orientation. On the other hand, an object which is too large with respect to the landing time can no longer offer sufficient structure to display an adequate orientation aid. Preferably, objects should be found which as far as possible are located in the direct field of view of the helmet sight system at the landing time, in order that the pilot need not turn his head to see the orientation aid. All of these criteria are expressed in a suitable weighting formula, which assesses the suitability of reference objects as orientation aids for landing, and quantifies them using a quality measure. If a plurality of objects with a quality measure above a defined threshold exist, i.e., objects which are suitable as an orientation aid which conforms with the outside view, the one which is chosen for further processing and display is that which has the highest quality-measure value.

In order to calculate and display the enveloping cuboid around the object selected as orientation aid, its major axis is calculated, for example, for the associated data points. The maximum extent of the associated data points is then searched for this purpose in all three spatial directions. A cuboid with this alignment and with the maximum extents is correspondingly drawn, standing on the measured ground surface. The position and the extent of this cuboid in earth-fixed relative coordinates are retained for the entire approach, until the landing has been completed.

It may likewise be advantageous, when very large objects are present, for these to be split algorithmically into object elements in order to ensure that the resultant orientation aid is of an optimum size. By way of example, a subelement of a long, laterally running wall can be split off and displayed.

By way of example, FIG. 10 shows a symbol 300, which conforms with the outside view, of the landing point and an additional cuboid orientation aid 301, which likewise conforms with the outside view and has been placed around a real object as an envelope.

One possible advantageous version of the proposed method may be to include more than one orientation aid. In this case, either the most suitable raised objects or all raised objects with a quality measure value above a predetermined threshold are provided with enveloping cuboids, and are shown.

In a further advantageous version, as an alternative to the cuboid, other geometric basic shapes may also be used as an orientation aid, for example, cylinders or cones. A mixture of different geometric basic shapes or an object-dependent selection of the geometric shapes of the envelopes is also advantageously possible within the scope of the proposed method.

In addition to the described symbols, which are derived from raised, real objects within or in front of the landing zone, it is also possible to use a purely virtual symbol which has no direct reference to a real object in the landing zone. This is likewise displayed to conform with the outside view in the helmet sight system. In particular, an orientation aid such as this can be used in a situation in which no raised real object at all is located in the area of the defined landing point. However, it is also possible to use a purely virtual symbol such as this in addition to the symbols described above, derived from a real object in the landing zone.

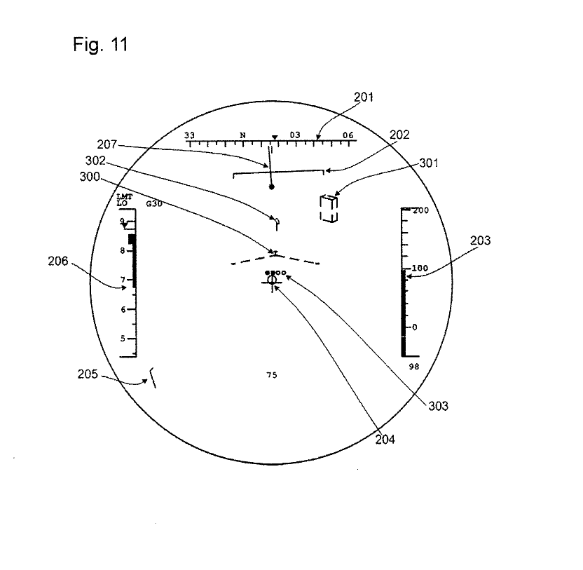

Advantageously, a symbol is selected which is known to the pilot from standard approaches in visual flight conditions, and can be used as an additional spatial reference or orientation point. For this purpose the use of a three-dimensional symbol in the form of a wind sock (reference number 302 in FIG. 11) is proposed, as is typically located adjacent to a normal helicopter landing area. The geometric dimensions of a wind sock such as this are well known by pilots, because of the applicable standards. The wind direction is implicitly transmitted as additional information, by aligning the virtual wind sock appropriately with the current wind direction in the helmet sight display.

As a further embodiment for a purely virtual symbol which has no actual correspondence with an object in the landing zone, a glide-angle beacon can be displayed, such that it conforms with the outside view, in the helmet sight system. This makes it possible to provide the pilot with assistance to maintain the correct approach angle.

A glide-angle beacon is an optical system as normally used in aviation, which makes it easier to maintain the correct glide path when approaching a runway. In this case, the VASI (Visual Approach Slope Indicator) and PAPI (Precision Approach Path Indicator) methods are suitable for the display according to the invention, in which, in the original form, a row of lamps changes its lamp color, depending on the approach angle to the landing point.

It appears to be particularly appropriate to display the glide-path angle by four red or white “lamps”, as provided in the PAPI system. When the glide-path angle is correct, the two left-hand lamps are red, and the two right-hand lamps are white. When the aircraft position is too low with respect to the desired glide path, the third and fourth lamps also turn red, and if the position is too high, the third and fourth lamps turn white.

A system such as this can also be implemented in a monochromic helmet sight system by displaying a white lamp as a circle and a red lamp as a filled circle or a circle with a cross (see reference number 303 in FIG. 11). When using a helmet sight system with the capability for color display, the colors red and white are advantageously used, which the pilot knows from his flying experience. Particularly when using the proposed system for brownout and whiteout landings, the existing landing procedures specify a very narrow corridor for the glide path, which is advantageously assisted by “PAPI” zymology which is slightly modified for these glide-path angles.

Both of the proposed symbols which conform with the outside view (wind sock and glide-angle beacon) have the advantage that they can be used very intuitively, since pilots are well aware of their use from their training and flying experience, and this advantageously reduces the workload during the approach.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A method for pilot assistance in landing an aircraft with restricted visibility, in which the position of a landing point is defined by at least one of a motion-compensated, aircraft-based helmet sight system and a remotely controlled camera during a landing approach, and with the landing point being displayed on a ground surface in the at least one of the helmet sight system and the remotely controlled camera by production of symbols that conform with the outside view, the method comprising:
one of producing or calculating during an approach, a ground surface based on measurement data from an aircraft-based 3D sensor; and
providing both the 3D measurement data of the ground surface and a definition of the landing point with reference to a same aircraft-fixed coordinate system.

2. The method according to claim 1, further comprising calculating, both in the aircraft-fixed coordinate system and in a local, ground-fixed relative coordinate system, geometric position data of landing point symbols,
wherein an instantaneous position in space and an instantaneous position of the aircraft are used for converting between the two coordinate systems, in which the instantaneous position of the aircraft results from relative position changes of the aircraft with respect to its position at a selected reference time.

3. The method according to claim 1, wherein the landing point is defined by finding a bearing of the landing point in the helmet sight system and subsequent marking by a trigger.

4. The method according to claim 1, further comprising correcting, via a control element, the position of the landing point symbol displayed in the helmet sight system.

5. The method according to claim 2, wherein the landing point symbols comprise at least one of an H, a T and an inverted Y.

6. The method according to claim 1, further comprising displaying at least one additional visual orientation aid, which conforms with an outside view and comprises a 3D object in the helmet sight system,
wherein the at least one additional visual orientation aid is derived from a real object within an area around the landing point.

7. The method according to claim 6, wherein the 3D data of the real object is produced by the 3D sensor during the approach.

8. The method according to claim 6, wherein the orientation aid comprises an envelope of the real object.

9. The method according to claim 6, wherein the orientation aid assumes a geometric basic shape comprising at least one of a cuboid, cone or cylinder, or combinations thereof.

10. The method according to claim 6, wherein, when there is a plurality of real objects within the landing zone, the method further comprises determining the suitability of the plurality of real objects as an orientation aid via of an assessment algorithm, and displaying the objects that are most suitable as orientation aids.

11. The method according to claim 1, further comprising displaying an additional, synthetic orientation aid, which conforms with the outside view and comprises a virtual wind sock in the helmet sight system.

12. The method according to claim 1, further comprising an additional synthetic orientation aid, which conforms with the outside view and comprises a virtual glide angle beacon in the helmet sight system, in order to assist the approach at the correct glide-path angle.

13. The method according to claim 12, wherein the virtual glide angle beacon comprises at least one of VASI (Visual Approach Slope Indicator) or PAPI (Precision Approach Path Indicator).

14. A method to assist landing an aircraft in an area of limited visibility comprising:
focusing on a landing point via one of a helmet system and a camera;
measuring a line of sight to the landing point;
3 dimensionally measuring an area that includes the landing point;
displaying symbols corresponding to an intersection of the line of sight and the 3 dimensionally measured area in the one of the helmet system and the camera.

15. The method according to claim 14, wherein measurement of the line of sight to the landing point is triggered by a pilot.

16. The method according to claim 14, further comprising correcting a location of the displayed the symbols according to additional measurements of the line of sight to the landing point and the area including the landing point.

17. The method according to claim 14, wherein the symbols comprise at least one of an H, a T and an inverted Y.
